(19) United States
(12) Patent Application Publication
(10) Pub. No.: US 2026/0035633 A1
(43) Pub. Date: Feb. 5, 2026

(54) SYSTEM AND METHOD FOR PRODUCING GAS HYDRATE

(71) Applicant: NUOVO PIGNONE TECNOLOGIE -S.R.L., Florence (IT)

(72) Inventors: Lorenzo BERGAMINI, Florence (IT); Balachandran KUMARAVELU, Florence (IT); Mallikarjuna Reddy PEDDI, Florence (IT); Uday Karthik MEDURI, Florence (IT); Vidyasagar RAMALINGAM RENGASAMY, Florence (IT); Ravindra DEVI, Florence (IT)

(21) Appl. No.: 19/099,864

(22) PCT Filed: Aug. 2, 2023
(86) PCT No.: PCT/EP2023/025364

§ 371 Date: Jan. 30, 2025

(30) Foreign Application Priority Data
Aug. 4, 2022 (IT) 102022000016626

(51) Int. Cl. C10L 3/10; C02F 1/00; C02F 103/08

(52) U.S. Cl. CPC C10L 3/108; C02F 1/00; C02F 2103/08; C02F 2301/066; C10L 2290/06

(57) ABSTRACT

A system for producing gas hydrate starting from a flow of unpurified water, comprising a multiphase multistage pump which receives at a main inlet, defining a first stage the flow of unpurified water and at a secondary inlet, defining an intermediate stage, a substance in gas state to form the hydrate. The pump is configured to increase the pressure of fluids and deliver pressurized fluids to a reactor which is configured to generate gas hydrate starting from the pressurized fluids. The reactor is configured to deliver fluid comprising gas hydrate, unreacted substance and/or water to a separator which has at least two outlets: a first (main) outlet which outputs gas hydrate and a second (secondary) outlet fluidly coupled to the secondary inlet and which outputs unreacted substance and/or water.

### DESCRIPTION

### Technical Field

The subject-matter disclosed herein relates to systems and methods for producing gas hydrate; one or more has hydrates may be produced at the same time depending on the embodiment. Such systems and methods may have several applications, some of them being disclosed herein; such systems may be part of different plants. They may be used for energy storage in the form of gas hydrate particles, or for substance purification, i.e. gas purification and/or water purification, in particular water desalination.

### Background Art

Desalination process is a known technique for water treatment, in particular for seawater or wastewater. Desalination is a process which consists in the separation of the saline species dissolved in the water from the solvent, thus allowing the production of pure water.

It is known (although not very common) that desalination may be carried out by hydrate formation, which are crystalline, ice-like structures that can store methane or other gases (such as hydrogen, carbon dioxide etc.) Pure water and gas form hydrates, excluding salts present in the water. The result of desalination is solid hydrates crystals with gas-trapped inside and concentrated brine, which is a high-concentration solution of salt (e.g. NaCl) in water (H₂O). After being separated from brine, the solid hydrate crystals upon dissociation produce pure water. In fact, the densities of gas hydrates are generally comparable to that of ice. Thus, gas hydrates typically will float above the water surface and may be easily separated from it.

In general, four components are required to form gas hydrates: water, a one or more substances (for example a hydrocarbon, in particular a light hydrocarbon, or a mixture of hydrocarbons) to form the hydrate of, low temperature, and high pressure. Gas hydrate formation is usually performed in a reactor in which a stream of high-pressure water and a stream of high pressure gas are supplied. Therefore, conventional gas hydrate systems have separate pumps and compressors to increase the pressure of the fluids to be fed to the reactor, the operating pressure being dependent on the type of hydrate to be formed and the nature of the gas.

From the article “Development of a novel hydrate-based refrigeration system: A preliminary overview” of Ogawa et al. it is known a hydrate-based closed cycle refrigeration system in order to improve conventional vapor-compression refrigeration systems. In the proposed system, a gas/liquid mixture forms hydrates so that the heat released by the exothermic formation of hydrates can be removed by an environmental fluid such as atmospheric air. According to the proposed system, the gas and the water are provided at the inlet of a multi-phase compressor and are compressed through the multi-phase compressor, i.e. a turbomachine which works efficiently with a low water/gas ratio. Moreover, according to the proposed system, the gas/liquid mixture is used as a working medium and is kept within the system (see FIG. 1).

From the document DE102009051277A1 it is known a system for producing gas hydrate using a multi-phase pump (which can work with a higher water/gas ratio with respect to compressors and therefore may reach a more effective mixing of the clathrate-forming fluids). According to this solution, the clathrate-forming fluids are mixed with one another before they are supplied together on the suction side of the multiphase pump (see for example stream 1, stream 2 and stream 3 of FIG. 1).

### SUMMARY

It would be desirable to have a gas hydrate production system which is more efficient than known systems, e.g. which has enhanced hydrate formation. Moreover, it would be desirable to have a gas hydrate production system which may be easily integrated in or combined with a plant, such as an energy storage plant or a water purification plant or a gas purification plant or a LNG plant.

According to an aspect, the subject-matter disclosed herein relates to a system for producing gas hydrate comprising a multiphase multistage pump which has a main pump inlet configured to receive a first fluid comprising water in liquid state (at ambient pressure or pre-pressurized) and to deliver it to an initial stage of the pump, at least one secondary pump inlet configured to receive a second fluid comprising a substance in gas state to form the hydrate of (at a pressure higher than ambient pressure or, in general, a pressure higher than the first fluid at the main pump inlet) and to deliver it to an intermediate stage of the pump, and a pump outlet configured to deliver a third fluid comprising the water and the substance to form the hydrate of at a predetermined pressure which is higher than the pressure of water at ambient pressure or pre-pressurized. The system further comprises a reactor which has a reactor inlet fluidly coupled to the pump outlet so to receive the third fluid and which is configured to generate gas hydrate starting from the third fluid and deliver a fourth fluid comprising gas hydrate, unreacted substance and/or water at a first reactor outlet. The system further comprises a separator which has a separator inlet fluidly coupled to the first reactor outlet so to receive the fourth fluid and which is configured to deliver unreacted substance and/or water to a secondary separator outlet (at a pressure higher than ambient pressure) fluidly coupled to the secondary pump inlet and to deliver gas hydrate at a main separator outlet.

According to another aspect, the subject-matter disclosed herein relates to a method for producing gas hydrate comprising the steps of:
supplying water to the first stage of a multiphase multistage pump;
supplying a substance in gas state to form the hydrate of to an intermediate stage of the multiphase multistage pump;
pumping a flow of water and substance to form the hydrate of in at least a last stage of the multiphase multistage pump and deliver the pumped flow to a reactor inlet;
generating gas hydrate starting from the pumped flow at the reactor inlet and delivering a flow comprising gas hydrate, unreacted substance and/or water to a main reactor outlet;
separating gas hydrate from unreacted substance and/or water in a separator and delivering gas hydrate to a main separator outlet and unreacted substance and/or water to a secondary separator outlet.

According to still other aspects, the subject-matter disclosed herein relates to a plant for producing purified water starting from unpurified water, in particular saline water, or a plant for producing purified gas starting from unpurified gas stream, in particular unpurified gas stream comprising hydrocarbons (for example methane, propane, “natural gas”, . . . ) or carbon dioxide or hydrogen or 1,1-dichloro-1-fluoroethane (so-called “R141B”), or a plant for producing gas hydrate for energy storage starting from a gas stream, in particular a gas stream comprising hydrocarbons.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a simplified diagram of a first embodiment of an innovative system for producing gas hydrate, in particular implemented in a plant for producing purified water,

FIG. 2 shows a simplified diagram of a second embodiment of an innovative system for producing gas hydrate, in particular implemented in a plant for producing purified water,

FIG. 3 shows a simplified diagram of a third embodiment of an innovative system for producing gas hydrate, in particular implemented in a plant for producing purified water,

FIG. 4 shows a simplified diagram of a fourth embodiment of an innovative system for producing gas hydrate, in particular implemented in a plant for producing purified gas,

FIG. 5 shows a simplified diagram of a fifth embodiment of an innovative system for producing gas hydrate, in particular implemented in a plant for producing purified gas,

FIG. 6 shows a simplified diagram of a sixth embodiment of an innovative system for producing gas hydrate, in particular implemented in a plant for energy storage, and

FIG. 7 shows a simplified diagram of a seventh embodiment of an innovative system for producing gas hydrate, in particular in a plant for producing purified gas starting from a gas stream containing at least two-gases.

### DETAILED DESCRIPTION OF EMBODIMENTS

According to an aspect, the subject-matter disclosed herein relates to a system for producing gas hydrate starting from a flow of unpurified water, for example waste water or saline water, in particular sea water. The system comprises a multiphase multistage pump which receives at a main inlet, which is at the first stage of the pump (i.e. at the suction side of the pump), the flow of unpurified water and at a secondary inlet, which is at an intermediate stage of the pump, a substance in gas state to form the hydrate of. Advantageously, the multiphase multistage pump is configured to process a substance, in particular gas, which is not at ambient pressure (i.e. it is not delivered at the main inlet of the pump at the first stage of the pump) but is at pressure higher then ambient pressure (i.e. a pressure higher than the first fluid at the main pump inlet). The pump is configured to increase the pressure of fluids and deliver pressurized fluids to a reactor which is configured to generate gas hydrate starting from the pressurized fluids. The reactor is configured to deliver fluid comprising gas hydrate, unreacted substance and/or water to a separator which has at least two outlets: a first (main) outlet which outputs gas hydrate and a second (secondary) outlet which is fluidly coupled to the secondary inlet and which outputs unreacted substance and/or water. An innovative system as described above can be implemented in different plants and can be used to produce purified water and/or purified gas or for energy storage in the form of gas hydrate particles. Advantageously, the innovative system may be combined with an LNG plant, which typically has a lot of cold energy which can be used to produce gas hydrate.

Reference now will be made in detail to embodiments of the disclosure, examples of which are illustrated in the drawings. The examples and drawing figures are provided by way of explanation of the disclosure and should not be construed as a limitation of the disclosure. In fact, it will be apparent to those skilled in the art that various modifications and variations can be made in the present disclosure without departing from the scope or spirit of the disclosure. In the following description, similar reference numerals are used for the illustration of figures of the embodiments to indicate elements performing the same or similar functions. Moreover, for clarity of illustration, some references may be not repeated in all the figures.

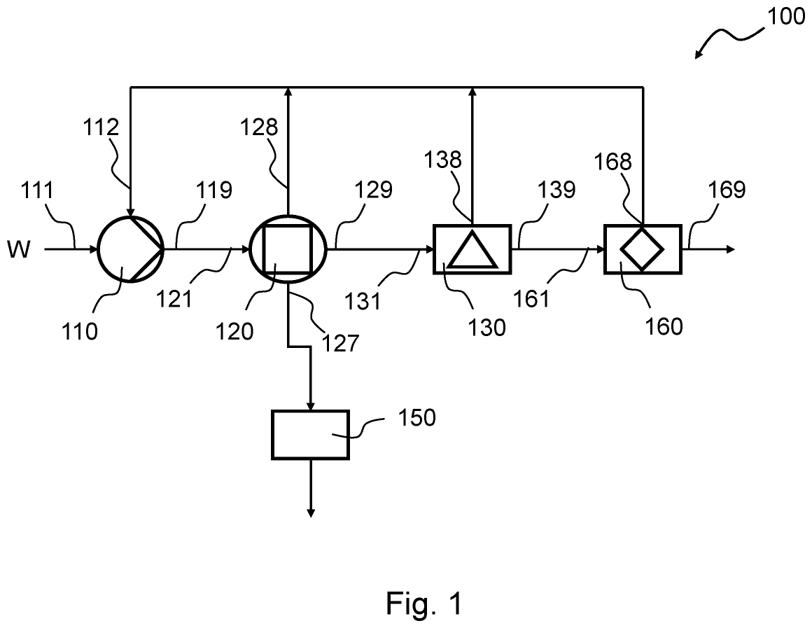

In FIG. 1 there is shown a simplified diagram of a first embodiment of an innovative system for producing gas hydrate generally indicated with reference numeral 100. The system 100 comprises at least a pump 110, a reactor 120 and a separator 130.

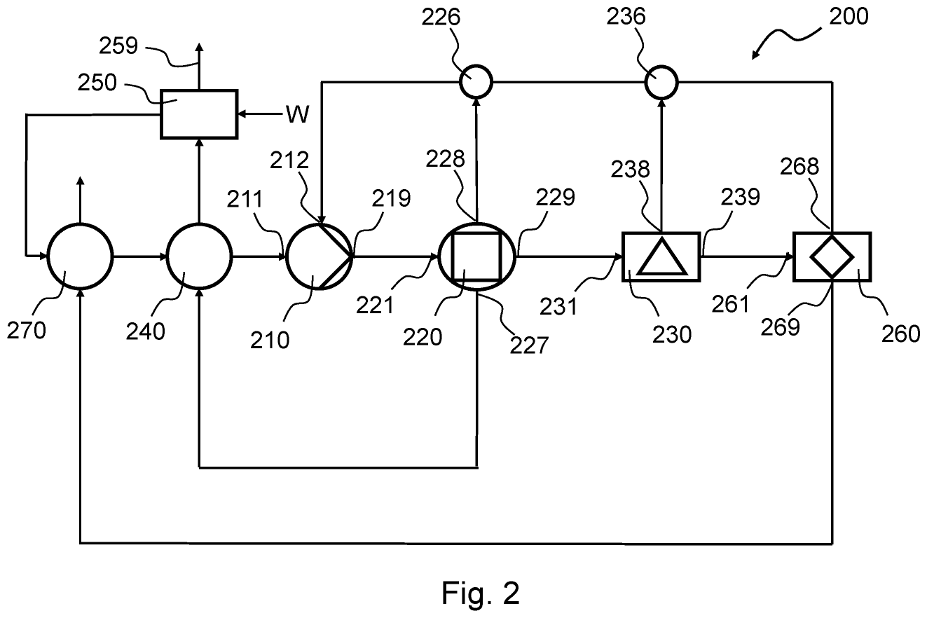

The pump 110 is a multiphase multistage pump and has a main pump inlet 111, a first secondary pump inlet 112 and a pump outlet 119. The main pump inlet 111 is configured to receive a first fluid W comprising water in liquid state at ambient pressure or pre-pressurized (as it will better explained considering FIGS. 2-5) and to deliver it to an initial stage of the pump 110; for example, the first fluid W may be waste water, in particular process water, or saline water, in particular sea water. As it will be apparent from the following, the first fluid W may be at ambient condition, for example sea water at 25° C. and ambient pressure, or can be advantageously cooled down and/or pre-pressurized in order to reduce the first fluid volume (and improve the efficiency of the system). The first secondary pump inlet 112 is configured to receive a second fluid comprising a substance in gas state to form the hydrate of at a pressure higher than ambient pressure and to deliver it to an intermediate stage of the pump 110. Advantageously but not limited to, the substance to form the hydrate of comprises hydrocarbons (for example methane, propane, natural gas . . . ) or carbon dioxide or hydrogen or 1,1-dichloro-1-fluoroethane. The pump outlet 119 is configured to deliver a third fluid comprising the water and the substance to form the hydrate of at a predetermined pressure, i.e. a pressure higher than ambient pressure, for example at 30-40 bar.

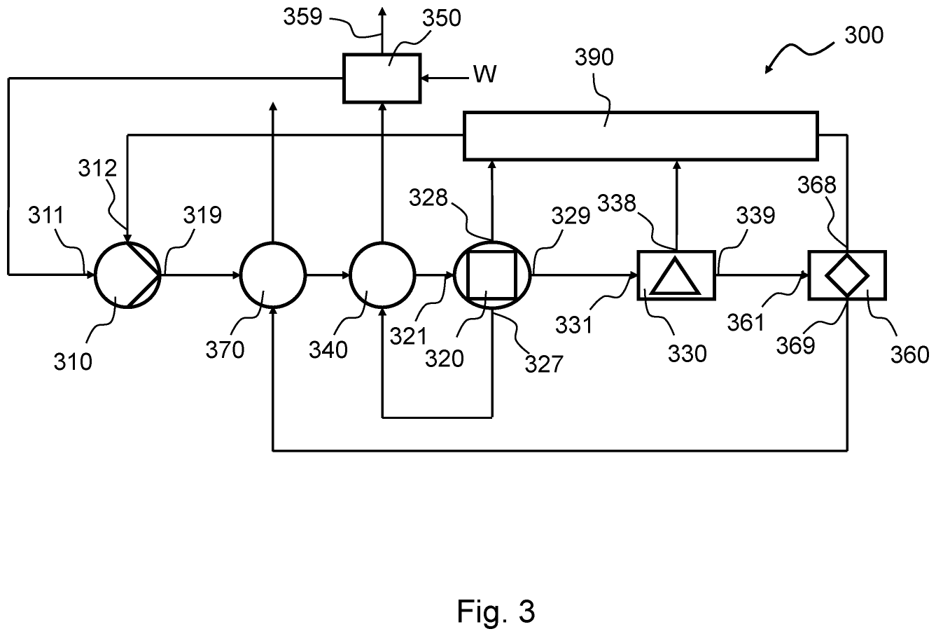

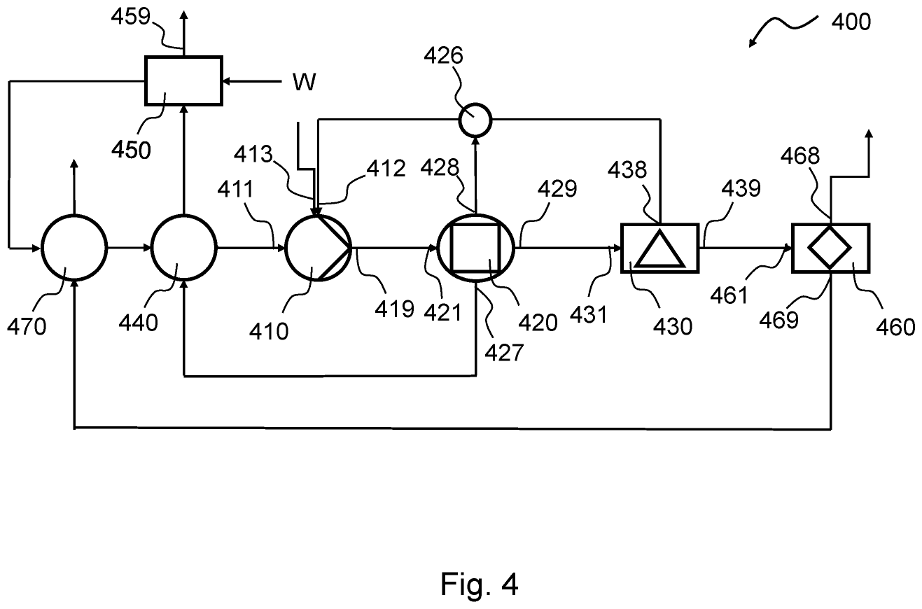

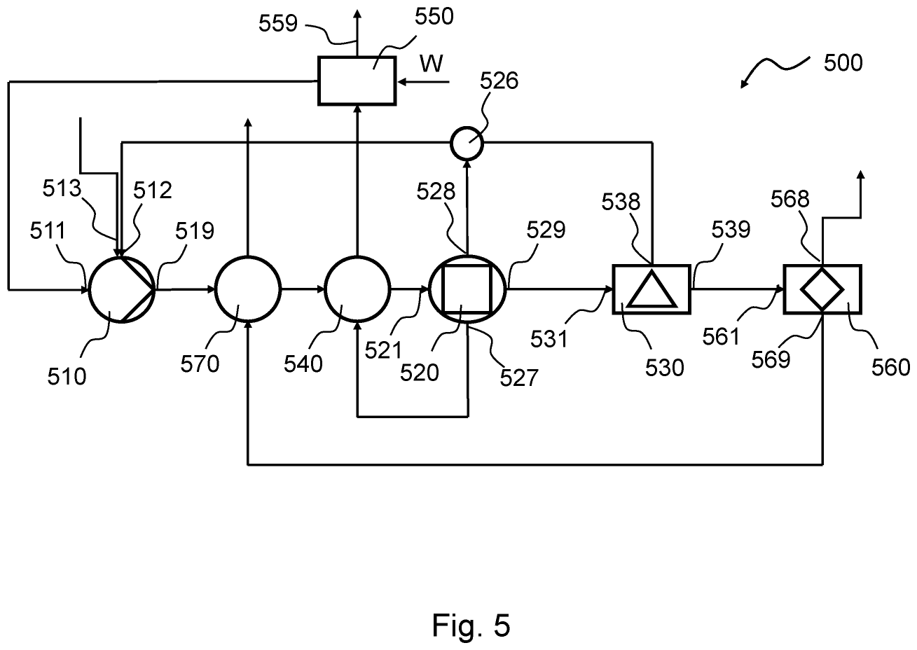

The reactor 120 has a reactor inlet 121 which is fluidly coupled to the pump outlet 119 so to receive the third fluid delivered by the pump outlet 119. The reactor 120 is configured to generate gas hydrate, which in general is crystalline water-based solids physically resembling ice with gas molecules trapped within, starting from the third fluid. For example, the temperature of the third fluid in the reactor 120 is in a range of minus 5-plus 25° C. For example, the pressure of the third fluid in the reactor 120 is in a range of 5 bar-50 bar. However, the optimal range for temperature and pressure is dependent on the properties of the fluids in the reactor 120. In particular, the reaction which is performed in the reactor 120 generates gas hydrate, which is typically in the form of pure water crystals with gas molecules trapped within, and a fifth stream (which in the following is referred to as brine, which typically is a high-concentration solution of salt(s)) comprising salt or salts deriving from the third fluid and possibly water in liquid state. It is to be noted that the brine may also contain other substances, such as solid particles from the waste water or saline water. Advantageously, the reactor 120 further comprises a third reactor outlet 127 configured to discharge the brine. It has also to be noted that brine may be still at high pressure (e.g. 30-40 bar); advantageously, the system 100 further comprises a pressure recovery unit 150 which is fluidly coupled to the third reactor outlet 127 and is configured to recover pressure energy from the brine. For example, the pressure energy recovered from the brine may be used to pre-pressurize the first fluid W before being delivered to the main pump inlet (with non-limiting reference to FIG. 2, FIG. 3, FIG. 4 and FIG. 5, there are shown embodiments in which the first fluid W is pre-pressurized in the pressure recovery unit 250 or 350 or 450 or 550). Advantageously, the pressure recovery unit 250 or 350 or 450 or 550 is fluidly coupled to the third reactor outlet 227 or 327 or 427 or 527 and uses the pressure energy from the brine to pre-pressurize the first fluid W; as it will better described in the following, the brine discharged from the third reactor outlet 227 or 327 or 427 or 527 may also be used to recover thermal energy, in particular cooling thermal energy. The pressure recovery unit 250 or 350 or 450 or 550 has further a main outlet 259 or 359 or 459 or 559 which is configured to discharge low-pressure and/or high temperature brine. According to another example not shown in the figures, the pressure energy recovered from the brine may be used to produce electrical energy, e.g. using a turbine, that may be supplied in particular to the multiphase multistage pump.

As it will be apparent from the following, the third fluid may not be completely affected by the reaction and part of the third fluid may be left unreacted. The reactor 120 has a first reactor outlet 129 which is configured to deliver a fourth fluid comprising gas hydrate, any unreacted substance and/or water. Advantageously, the reactor 120 has further a second reactor outlet 128 which is fluidly coupled to the first secondary pump inlet 112 and which is configured to deliver a stream comprising unreacted substance and possible water to the first secondary pump inlet 112.

According to a first possibility (shown for example in FIG. 1), the stream delivered by the second reactor outlet 128 is directly delivered to the first secondary pump inlet 112 at an intermediary stage of the pump 110, in order to advantageously efficiently use the enthalpy of the stream delivered by the second reactor outlet 128; in other words, the pressure of the stream delivered by the second reactor outlet 128 is substantially the pressure at the intermediary stage of the first secondary pump inlet 112, in particular slightly higher than the pressure at the intermediary stage of the first secondary pump inlet 112. According to a second possibility (shown for example in FIG. 2, and also in FIG. 4 and FIG. 5), the stream delivered by the second reactor outlet 228 has a pressure higher than the pressure at the intermediary stage of the first secondary pump inlet 212; advantageously, the system 200 further comprises at least one first pressure reducing device 226, in particular a Venturi mixer or an ejector or any device performing the same function, to adjust the pressure of the stream in order to reach substantially the pressure at the intermediary stage of the first secondary pump inlet 212. With non-limiting reference to FIG. 2, the stream delivered by the second reactor outlet 228 is at pressure higher than the stream delivered by the secondary separator outlet 238 and the stream delivered by the secondary separator outlet 238 has a pressure higher than the stream delivered by the second reactor outlet 228; advantageously, the pressure reducing device 226 exploits the Venturi effect to allow the low-pressure stream coming from the secondary separator outlet 238 to merge with the high-pressure stream coming from the second reactor outlet 228. The merged stream which exits from the pressure reducing device 226 is substantially at an intermediate pressure between the high-pressure stream and the low-pressure stream, advantageously at a pressure slightly higher than the pressure at the intermediary stage of the first secondary pump inlet 112, so to be delivered to the first secondary pump inlet 112. Advantageously, the system 200 further comprises a second pressure reducing device 236, as it will better described in the following. According to a third possibility (not shown in the figures), the pump comprises further another secondary pump inlet downstream the first secondary pump inlet (i.e. at an intermediate stage of the pump which has higher pressure) and the stream delivered by the second reactor outlet which has a pressure higher than the pressure at the intermediary stage of the first secondary pump inlet is delivered directly to the another secondary pump inlet; in other words, the pressure of the stream delivered by the second reactor outlet is substantially the pressure at the intermediary stage of the another secondary pump inlet.

The separator 130, for example a separator with water wash or a gravity separator, has a separator inlet 131, which is fluidly coupled to the first reactor outlet 129 so to receive the fourth fluid delivered by the first reactor outlet 129, a main separator outlet 139 and a secondary separator outlet 138. The separator 130 is configured to supply unreacted substance and/or water to the secondary separator outlet 138 at a pressure higher than ambient pressure and to supply gas hydrate at the main separator outlet 139. The secondary separator outlet 138 is fluidly coupled to the secondary pump inlet 112 so to deliver the unreacted substance and/or water to the secondary separator outlet 138.

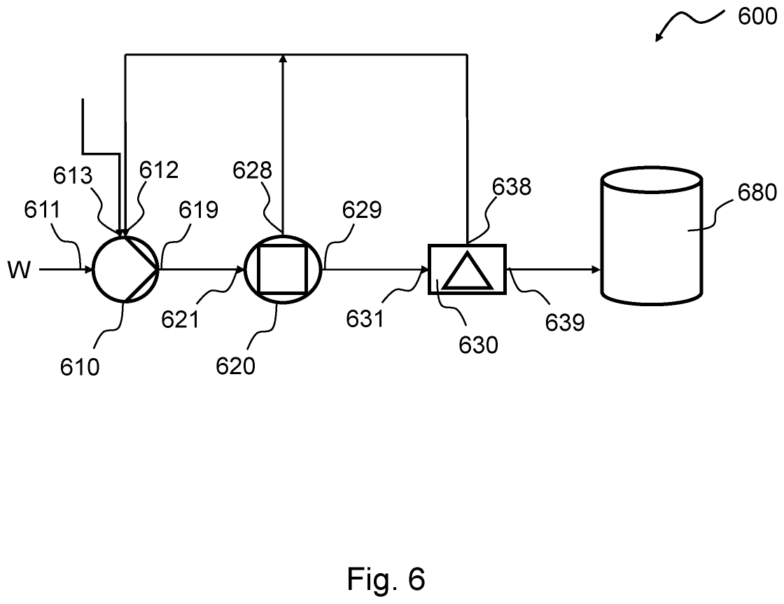

According but non-limiting to the embodiment of FIG. 6, the main separator outlet 639 may supply gas hydrate to a storage system 680. In particular, the pump 610 has a second secondary pump inlet 613 configured to receive a gas stream of the substance to form the hydrate of at a pressure higher than ambient pressure and to deliver to an intermediate stage of the pump 610. Advantageously, the substance to form the hydrate of received by the second secondary pump inlet 613 comprises hydrocarbons (for example methane, propane, natural gas . . . ) or carbon dioxide or hydrogen or 1,1-dichloro-1-fluoroethane; preferably, the substance to form the hydrate of comprises methane. It is to be noted that the first secondary pump inlet 612 and the second secondary pump inlet 613 may deliver respectively a stream comprising unreacted substance and possible water and a stream of the substance to form the hydrate of to the same intermediate stage of the pump 610; in other word, the first secondary pump inlet 612 and the second secondary pump inlet 613 may coincide.

Advantageously, with non-limiting reference to FIGS. 2-5, the system 200 or 300 or 400 or 500 further comprises a first heat exchanger 240 or 340 or 440 or 540 which is fluidly coupled to the third reactor outlet 227 or 327 or 427 or 527. In particular, the first heat exchanger 220 or 320 or 420 or 520 may exploit the residual cooling energy of the brine discharged by the third reactor outlet 227 or 327 or 427 or 527. For example, as shown in FIG. 2 and FIG. 4, the first heat exchanger 240 or 440 may be located upstream of the pump 210 or 410 (e.g. directly upstream) and may be configured to transfer heat from the first fluid W to the fifth stream; in other words, the first heat exchanger 240 or 440 is configured to cool the first fluid W before it is delivered to the main pump inlet 211 or 411. For example, as shown in FIG. 3 and FIG. 5, the first heat exchanger 340 or 540 may be located downstream the pump 310 or 510 (e.g. directly upstream the reactor 320 or 520) and may be configured to transfer heat from the third fluid to the fifth stream; in other words, the first heat exchanger 340 or 540 is configured to cool the third fluid before it is delivered to the reactor inlet 321 or 521.

Advantageously, with non-limiting reference to FIGS. 1-5, the system 100 or 200 or 300 or 400 or 500 further comprises a disassociator 160 or 260 or 360 or 460 or 560 configured to perform gas hydrate disassociation, typically by reducing pressure and possibly by increasing temperature. For the sake of clarity, reference will now be made to the embodiment of FIG. 1. Advantageously, the disassociator 160 has a disassociator inlet 161 which is fluidly coupled to the main separator outlet 139 and receives gas hydrate from the main separator outlet 139. Advantageously, the disassociator 160 has further a main disassociator outlet 169 and a secondary disassociator outlet 168. As described above, the disassociator 160 is configured to perform gas hydrate disassociation and deliver a stream of purified water to the main disassociator outlet 169 and deliver a stream of purified gas to the secondary disassociator outlet 168. It has to be noted that the disassociator 160 may also been configured to store the gas hydrates for a predetermined time: for example, the disassociator 160 may operate as a gas hydrate storage for a certain period, in particular not changing the pressure and/or temperature of gas hydrates in the disassociator 160 and storing it, and operate to perform gas hydrate disassociation for another certain period, in particular when there is demand for energy. According to another possibility, the system may also comprise a separate storage tank (see e.g. element 390 in FIG. 3) which is fluidly coupled to the secondary disassociator outlet 368 and to the secondary pump inlet 312 and which can store for a certain time at least the purified gas received from the secondary disassociator outlet 368 before supplying purified gas to the secondary pump inlet 312. Advantageously, the storage tank 390 may also be fluidly coupled to the secondary separator outlet 338 and/or to the second reactor outlet 328, in order to store unreacted substance and/or water delivered by the secondary separator outlet 338 and/or the second reactor outlet 328. According to another possibility, the system 200 may further comprise also a second pressure reducing device 236, in particular a Venturi mixer or an ejector or any device performing the same function, which is fluidly coupled to the secondary separator outlet 238 and to the secondary disassociator outlet 268. With non-limiting reference to FIG. 2, the stream delivered by the secondary separator outlet 238 is at pressure higher than the stream delivered by the secondary disassociator outlet 268. Advantageously, the pressure reducing device 236 exploits the Venturi effect to allow the low-pressure stream coming from the secondary disassociator outlet 268 to merge with the high-pressure stream coming from the secondary separator outlet 238. The merged stream which exits from the pressure reducing device 236 is substantially at an intermediate pressure between the high-pressure stream and the low-pressure stream, advantageously at a pressure lower than the stream coming from the second reactor outlet 228.

Advantageously, with non-limiting reference to FIGS. 2-5, the system 200 or 300 or 400 or 500 further comprises a second heat exchanger 270 or 370 or 470 or 570 which is fluidly coupled to the main disassociator outlet 269 or 369 or 469 or 569. In particular, the second heat exchanger 270 or 370 or 470 or 570 may exploit the residual cooling energy of the purified water discharged by the main disassociator outlet 269 or 369 or 469 or 569. For example, as shown in FIG. 2 and FIG. 4, the second heat exchanger 270 or 470 may be located upstream the pump 210 or 420, in particular upstream the first heat exchanger 240 or 440, and may be configured to transfer heat from the first fluid W to the stream of purified water; in other words, the second heat exchanger 270 or 470 is configured to cool the first fluid W before it is delivered to the main pump inlet 211 or 411, in particular before being further cooled by the first heat exchanger 240 or 440. For example, as shown in FIG. 3 and FIG. 5, the second heat exchanger 370 or 570 may be located downstream the pump 310 or 510 (e.g. directly downstream of the pump 310 or 510) and may be configured to transfer heat from the third fluid to the stream of purified water; in other words, the second heat exchanger 370 or 570 is configured to cool the third fluid before it is delivered to the reactor inlet 321 or 521, in particular before being further cooled by the first heat exchanger 340 or 540. It is to be noted that, according to a possibility (not shown in any figure) the second heat exchanger 270 or 370 or 470 or 570 may be integrated in the disassociator 260 or 360 or 460 or 560, for example in the forms of coils around the disassociator 260 or 360 or 460 or 560.

As it is apparent from FIGS. 1-3, the system 100 or 200 or 300 may recirculate the stream of purified gas to the pump 110 or 210 or 310, in particular to an intermediate stage of the pump. Advantageously, the secondary disassociator outlet 168 or 268 or 368 is fluidly coupled to the secondary pump inlet 112 or 212 or 312 and the secondary pump inlet 112 or 212 or 312 is configured to receive the stream of purified gas from the secondary disassociator outlet 168 or 268 or 368. In other words, the circulation of gas in the system 100 or 200 or 300 may be defined as a closed-loop circulation. It is to be noted that the main output of the system 100 or 200 or 300 may be purified water. In other words, the system 100 or 200 or 300 is particularly suitable for producing purified water and may be implemented in a plant for producing purified water starting from unpurified water, in particular saline water, which is supplied to the main pump inlet 111 or 211 or 311.

As it is apparent from FIGS. 4 and 5, the system 400 or 500 may not recirculate the stream of purified gas to the pump 410 or 510 (in other words, the circulation of gas in the system 400 or 500 may be defined as an open-loop circulation). In fact, the main output of the system 400 or 500 may be purified gas starting from a stream of unpurified gas. In particular, the pump 410 or 510 has a second secondary pump inlet 413 or 513 configured to receive a gas stream of a substance to form the hydrate of at a pressure higher than ambient pressure and to deliver it to an intermediate stage of the pump 410 or 510. Advantageously, the substance to form the hydrate of received by the second secondary pump inlet 413 or 513 comprises hydrocarbons (for example methane, propane, natural gas . . . ) or carbon dioxide or hydrogen or 1,1-dichloro-1-fluoroethane. It is to be noted that the first secondary pump inlet 412 or 512 and the second secondary pump inlet 413 or 513 may deliver respectively a stream comprising unreacted substance and possible water and a stream of the substance to form the hydrate of to the same intermediate stage of the pump 410 or 510; in other word, the first secondary pump inlet 412 or 512 and the second secondary pump inlet 413 or 513 may coincide.

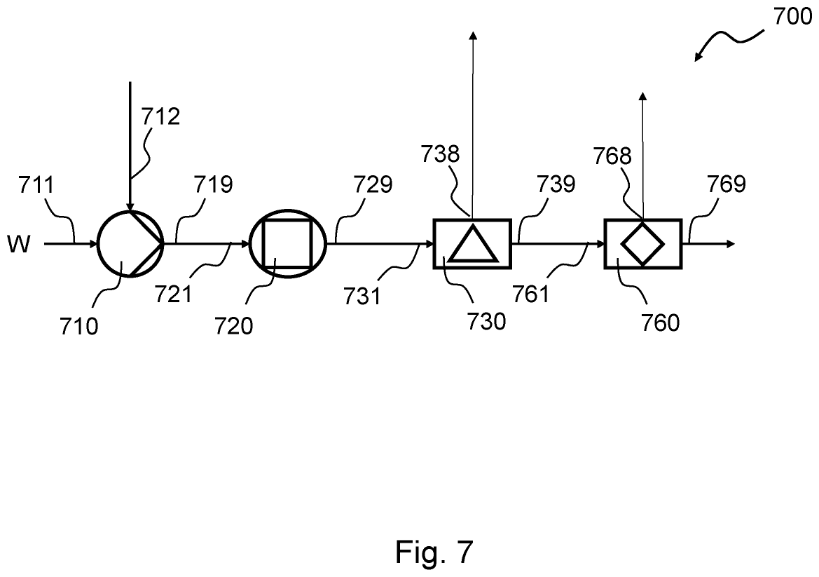

Another embodiment 700 of a system for producing gas hydrate will be described in the following with the aid of FIG. 7. It is to be noted that elements 711, 719, 721 and 731 in FIG. 7 may be identical or similar respectively to elements 111 (main pump inlet), 119 (pump outlet), 121 (reactor inlet) and 131 (separator inlet) in FIG. 1 and perform the same or similar functions. According to the embodiment shown in FIG. 7, the main output of the system 700 may be purified gas starting from a stream of unpurified gas, in particular from a gas stream containing at least two-gases. With non-limiting reference to FIG. 7, the first secondary pump inlet 712 is configured to receive a gas stream comprising a substance to form the hydrate of at a pressure higher than ambient pressure and to deliver it to an intermediate stage of the pump 710. In particular, the gas stream at the first secondary pump inlet 712 may contain at least two gases: a first gas which is configured to react in the reactor 720 and form hydrate gas and a second gas (or mixture of gases) which does not react (i.e. does not form hydrate gas). The fourth fluid at the first reactor outlet 729 comprises gas hydrate formed by the first gas, unreacted substance, in particular unreacted second gas, and/or water and is delivered to the separator 730. The separator 730 is configured to separate the fourth fluid and to supply gas hydrate at the main separator outlet 739 and unreacted gas at the secondary separator outlet 738, which in particular is pure second gas. The main separator outlet 739 is fluidly coupled to the disassociator 760 which is configured to perform gas hydrate dissociation and to deliver a stream of purified water to the main disassociator outlet 769 and a stream of purified gas to the secondary disassociator outlet 768, which in particular is pure first gas.

In other words, the system 400 or 500 or 700 is particularly suitable for producing purified gas and may be implemented in a plant for producing purified gas starting from unpurified gas stream which is, for example, the substance to form the hydrate of, in particular comprising natural gas or carbon dioxide or hydrogen or propane or 1,1-dichloro-1-fluoroethane, which is supplied to the second secondary pump inlet 413 or 513. In particular, system 700 is suitable for producing purified gas from a gas stream containing at least two-gases.

As it is apparent from FIG. 6, the main output of the system 600, in particular from the separator 630, may be gas hydrate which may be stored in a storage system 680 (e.g. in the form of pellets). For example, the storage system 680 may store gas hydrate at ambient pressure and temperature of around −20° C. (gas hydrate stored at these conditions has in particular seven times the energy density-which means less storage space required-then the one that would have LNG if stored at ambient pressure (it has to be stored at around −161° C., which is liquefaction temperature of natural gas at ambient pressure). In other words, the system 600 is particularly suitable for producing gas hydrate for energy storage and may be implemented in a plant for producing gas hydrate for energy storage starting from a gas stream which is, for example, the substance to form the hydrate of, in particular comprising hydrocarbons, which is supplied to the second secondary pump inlet 613.

According to another aspect, the subject-matter disclosed herein relates to a method for producing gas hydrate comprising the steps of:
supplying a first fluid comprising water in the first stage of a multiphase multistage pump;
supplying a substance in gas state to form the hydrate of to an intermediate stage of the multiphase multistage pump;
pumping and pressurizing a flow of first fluid and substance to form the hydrate of in at least a last stages of the multiphase multistage pump and deliver the pumped flow to a reactor inlet;
generating gas hydrate starting from the pumped flow at the reactor inlet and delivering a flow comprising gas hydrate, unreacted substance and/or water to a main reactor outlet;
separating gas hydrate from unreacted substance and/or water in a separator and delivering gas hydrate to a main separator outlet and unreacted substance and/or water to a secondary separator outlet.

Advantageously, unreacted substance and/or water from the secondary separator outlet may be recirculated to the intermediate stage of the multiphase multistage pump.

According to a possibility, the gas hydrate from the main separator outlet may be delivered to a disassociator and the method may comprise further the step of dissociating gas hydrate in the disassociator and delivering purified water to a main disassociator outlet and purified gas to a secondary disassociator outlet. Advantageously, the purified gas from the secondary disassociator outlet may be recirculated to the intermediate stage of the multiphase multistage pump. According to another possibility, the gas hydrate from the main separator outlet may be delivered to a storage system which may store gas hydrate (e.g. in the form of pellets) for a predetermined time.

It is to be noted that, although exemplary embodiments have been described above in some exemplary combination of components and/or functions, alternative embodiments may be provided by different combinations of components and/or functions without departing from the scope of the present disclosure. In addition, it is to be noted that a particular feature described, either individually or as part of an embodiment, can be combined with other individually described features, or parts of other embodiments.

1. A system for producing gas hydrate comprising:
a pump having a main pump inlet, at least one secondary pump inlet and a pump outlet wherein the pump is a multiphase multistage pump, wherein the main pump inlet is configured to receive a first fluid comprising water in liquid state at ambient pressure or pre-pressurized and to deliver it to an initial stage of the pump, wherein a first secondary pump inlet is configured to receive a second fluid comprising a substance in gas state to form the hydrate of at a pressure higher than ambient pressure or pre-pressurized and to deliver it to an intermediate stage of the pump wherein the pump outlet is configured to deliver a third fluid comprising the water and the substance to form the hydrate of at a predetermined pressure which is higher than the pressure of water at ambient pressure or pre-pressurized;
a reactor having a reactor inlet and at least one reactor outlet, wherein the reactor inlet is fluidly coupled to the pump outlet so to receive the third fluid, wherein the reactor is configured to generate gas hydrate starting from the third fluid and deliver a fourth fluid comprising gas hydrate, unreacted substance and/or water at a first reactor outlet,
a separator having a separator inlet a main separator outlet, and a secondary separator outlet wherein the separator inlet is fluidly coupled to the first reactor outlet so to receive the fourth fluid, wherein the separator is configured to supply unreacted substance and/or water to the secondary separator outlet at a pressure higher than ambient pressure and to supply gas hydrate at the main separator outlet;
wherein the secondary separator outlet is fluidly coupled to the first secondary pump inlet.

2. The system of claim 1, wherein the reactor further comprises a second reactor outlet fluidly coupled to the secondary pump inlet,
wherein the second reactor outlet is configured to deliver a stream comprising unreacted substance and possible water to the secondary pump inlet.

3. The system of claim 1, wherein the pump has further a second secondary pump inlet configured to receive a gas stream of a substance to form the hydrate of at a pressure higher than ambient pressure and to deliver it to an intermediate stage of the pump.

4. The system of claim 3, wherein the gas stream comprises hydrocarbons or carbon dioxide or hydrogen or 1,1-dichloro-1-fluoroethane.

5. The system of claim 1, wherein the reactor further comprises a third reactor outlet configured to discharge a fifth stream comprising salt or salts deriving from the third fluid and possibly water in liquid state.

6. The system of claim 5, further comprising a pressure recovery unit fluidly coupled to the third reactor outlet, wherein the pressure recovery unit is configured to recover pressure energy from the fifth stream.

7. The system of claim 5, further comprising a first heat exchanger fluidly coupled to the third reactor outlet, wherein the first heat exchanger is configured to transfer heat from the first fluid to the fifth stream.

8. The system of claim 5, further comprising a first heat exchanger fluidly coupled to the third reactor outlet, wherein the first heat exchanger is configured to transfer heat from the third fluid to the fifth stream.

9. The system of claim 1, further comprising a disassociator having a disassociator inlet a main disassociator outlet and a secondary disassociator outlet, wherein the disassociator inlet is fluidly coupled to the main separator outlet, wherein the disassociator is configured to perform gas hydrate dissociation and to deliver a stream of purified water to the main disassociator outlet and a stream of purified gas to the secondary disassociator outlet.

10. The system of claim 9, wherein the secondary disassociator outlet is fluidly coupled to the secondary pump inlet, wherein the secondary pump inlet is configured to receive the stream of purified gas from the secondary disassociator outlet.

11. The system of claim 9, further comprising a second heat exchanger fluidly coupled to the main disassociator outlet, wherein the second heat exchanger is configured to transfer heat from the first fluid W to the stream of purified water delivered to the main disassociator outlet.

12. The system of claim 9, further comprising a second heat exchanger fluidly coupled to the main disassociator outlet, wherein the second heat exchanger is configured to transfer heat from the third fluid to the stream of purified water delivered to the main disassociator outlet.

13. A plant for producing purified water starting from unpurified water, wherein the plant comprises the system of claim 9, wherein the unpurified water is supplied to the main pump inlet.

14. A plant for producing purified gas starting from unpurified gas stream, wherein the plant comprises the system of claim 1, wherein the unpurified gas stream is supplied to the first secondary pump inlet or to the second secondary pump inlet.

15. A plant for producing gas hydrate for energy storage starting from a gas stream, wherein the plant comprises the system of claim 3, wherein the gas stream is supplied to the second secondary pump inlet.

16. A method for producing gas hydrate comprising the steps of:
supplying a first fluid comprising water to a first stage of a multiphase multistage pump;
supplying a substance in gas state to form the hydrate of to an intermediate stage of the multiphase multistage pump;
pumping and pressurizing a flow of first fluid and substance to form the hydrate of in at least a last stage of the multiphase multistage pump and deliver the pumped flow to a reactor inlet;
generating gas hydrate starting from the pumped flow at the reactor inlet and delivering a flow comprising gas hydrate, unreacted substance and/or water to a main reactor outlet;
separating gas hydrate from unreacted substance and/or water in a separator and supplying gas hydrate to a main separator outlet and supplying unreacted substance and/or water to a secondary separator outlet.

17. The method of claim 16, further comprising the step of recirculating one or more of: unreacted substance; or, water, from the secondary separator outlet to the intermediate stage of the multiphase multistage pump.

18. The method of claim 16, further comprising the step of dissociating gas hydrate from the main separator outlet in a disassociator and delivering purified water to a main disassociator outlet and purified gas to a secondary disassociator outlet.

19. The method of claim 18, further comprising the step of recirculating purified gas from the secondary disassociator outlet to the intermediate stage of the multiphase multistage pump.

20. The method of claim 16, further comprising the step of storing gas hydrate from the main separator outlet in a storage system for a predetermined time.
